(19) United States
(12) Patent Application Publication
(10) Pub. No.: US 2007/0009280 A1
(43) Pub. Date: Jan. 11, 2007

(54) Electronic apparatus

(75) Inventor: Isao Kubo, Nagoya-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/481,788

(22) Filed: Jul. 7, 2006

(30) Foreign Application Priority Data
Jul. 8, 2005 (JP) 2005-200480

(51) Int. Cl. G03G 15/00

(52) U.S. Cl. 399/88

(57) ABSTRACT

An electronic apparatus includes: an electronic part attachment member including a plurality of electronic parts; and an electric connection unit provided on the electronic part attachment member, the electric connection unit including: a first power source terminal that supplies a drive power source to the electronic parts; and a plurality of signal terminals through which an electric signal input into the electronic parts flows, wherein: the first power source terminal and the plurality of signal terminals are arranged in an substantially straight line; the first power source terminal is disposed in a longitudinal direction approximate center of the electric connection unit; and the signal terminals are disposed on at least one side in a longitudinal direction of the electric connection unit with respect to the first power source terminal.

### CROSS-REFERENCE TO THE RELATED APPLICATION(S)

This application is based upon and claims a priority from prior Japanese Patent Application No. 2005-200480 filed on Jul. 8, 2005, the entire contents of which are incorporated herein by reference.

### TECHNICAL FIELD

Aspects of the present invention relate to an electronic apparatus equipped with a connector semi-insertion detection function. In particular, the electronic apparatus can be beneficial when applied to an electrophotographic image forming apparatus.

### BACKGROUND

In order to prevent non-insertion or a semi-insertion of a connector when inserting a flexible flat cable (hereafter referred to as an FFC) in the connector on a circuit board, terminals on both ends of the connector are set to be power source terminals. The terminals on the both ends of the connector are prone to come off most easily. The semi-insertion of the connector can be detected by detecting whether or not a power source supplied from a periphery via the FFC is supplied normally to the circuit board (see JP-A-2002-178490).

### SUMMARY

However, in the event that a condition continues in which only a signal is input while a power source is not supplied, there is a high possibility of damage and a shortening of a life span of an electronic part.

Also, in the semi-insertion detection method disclosed in JP-A-2002-178490, since the power source terminals are positioned on easily detachable ends of the connector, a case may arise wherein only signals are input while the power source is not supplied to the electronic part installed on the circuit board and the connector is in a semi-inserted condition. This occurs when a terminal other than the power source terminals positioned on the both ends of the connector is in a connected condition.

Therefore, in the semi-insertion detection method disclosed in JP-A-2002-178490, it is difficult to detect the semi-insertion of a cable without damaging the electronic part.

Aspects of the present invention provide an electronic apparatus, in which even when a cable connected is in a semi-inserted condition, the semi-inserted condition of the cable can be detected without damaging an electronic part on a circuit board.

According to an aspect of the invention, there is provided an electronic apparatus including: an electronic part attachment member including a plurality of electronic parts; and an electric connection unit provided on the electronic part attachment member, the electric connection unit including: a first power source terminal that supplies a drive power source to the electronic parts; and a plurality of signal terminals through which an electric signal input into the electronic parts flows, wherein the first power source terminal and the plurality of signal terminals are arranged in an substantially straight line; the first power source terminal is disposed in a longitudinal direction approximate center of the electric connection unit; and the signal terminals are disposed on at least one side in a longitudinal direction of the electric connection unit with respect to the first power source terminal.

### BRIEF DESCRIPTION OF THE DRAWINGS

These and other objects and advantages of the present invention will be more fully apparent from the following detailed description taken in conjunction with the accompanying drawings, in which:

FIG. 1 is a perspective view showing a configuration of a laser printer according to an aspect;

FIG. 2 is a sectional view of the laser printer according to the aspect;

FIG. 3 is an outline configuration view of a scanner;

FIG. 4 is a diagram showing a terminal arrangement of a connector;

FIG. 5 is a diagram showing an electrical connection relationship between a PD board and a main board; and

FIGS. 6A and 6B are diagrams showing an insertion condition of a lead with respect to the connector.

### DETAILED DESCRIPTION OF THE ILLUSTRATIVE ASPECTS

An aspect of the invention will be described hereafter along with the drawings. Herein, a laser printer is exemplified as an electronic apparatus.

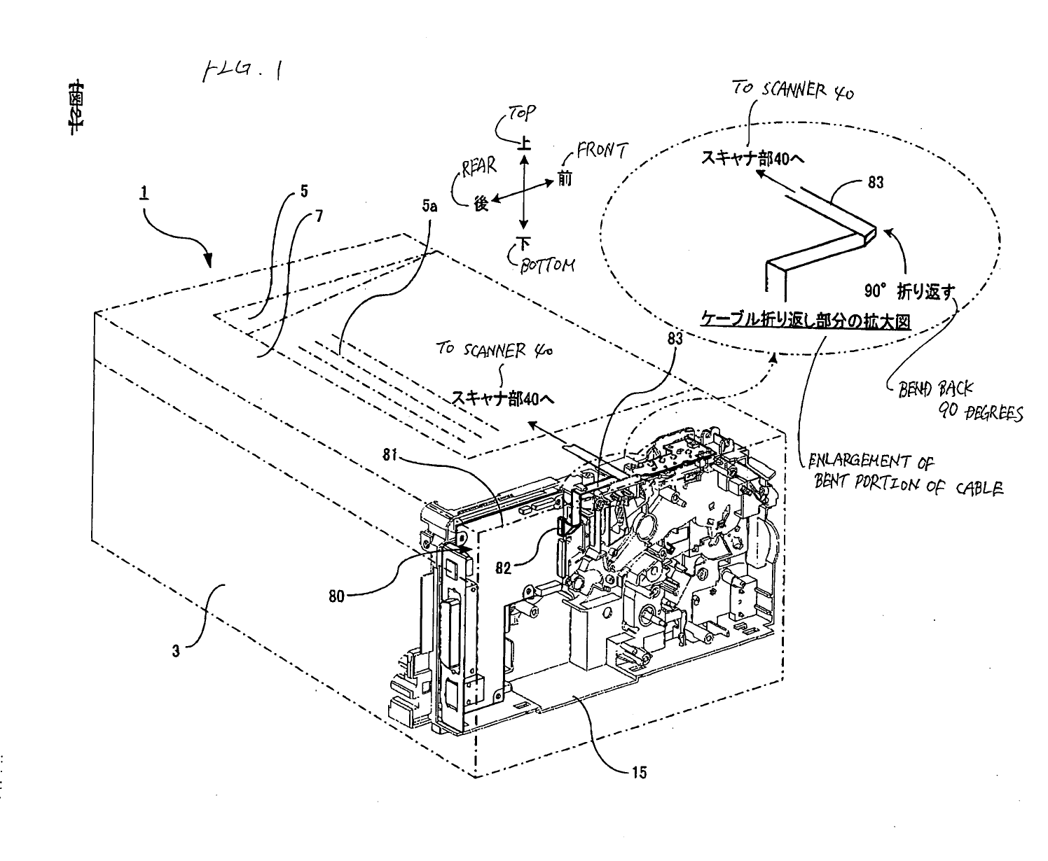

FIG. 1 is a perspective view showing an external appearance of the laser printer 1 according to the aspect. This laser printer 1 is installed with a top side of sheet of FIG. 1 as an upper side of a gravitational force direction. Also, diagonally far side (right side) of FIG. 1 normally serves as a front side.

A casing 3 of the laser printer 1 is substantially box-shaped (a cuboid shape). A sheet discharge tray 5, on which a recording medium which has been subjected to printing and has been discharged from the casing 3 is loaded, is provided on a top of the casing 3. In this aspect, it is a recording medium such as a paper sheet or an OHP sheet is used as the recording medium.

Also, the sheet discharge tray 5 includes an inclined surface 5a, which is recessed on the top surface of the casing 3 and is sloped down towards a rear side. A discharge unit 7, from which the recording medium, which has been subjected to printing, is discharged, is provided at a rear end of the inclined surface 5a.

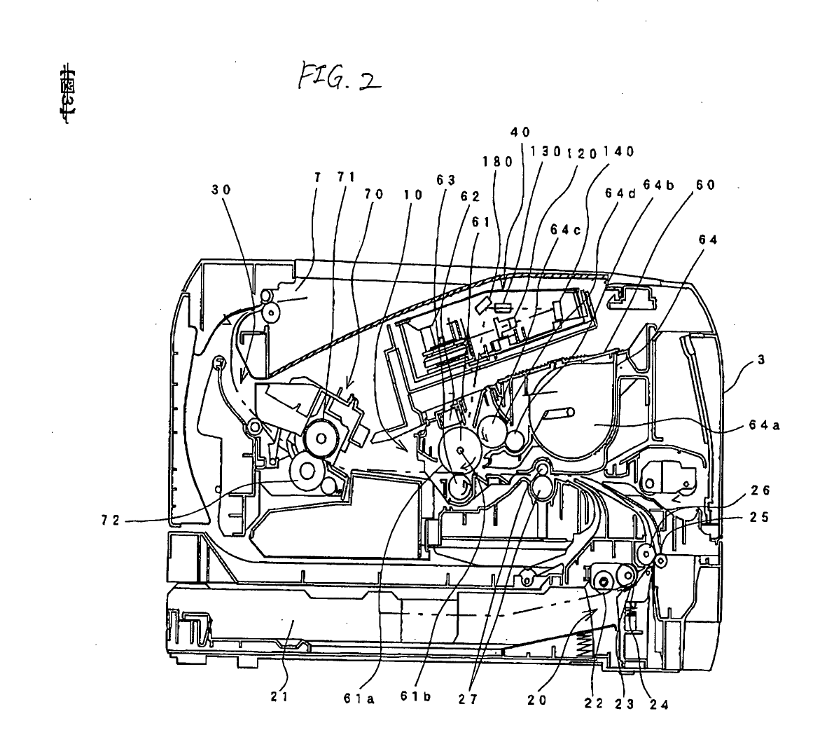

FIG. 2 is a sectional side view of the laser printer 1. An image forming unit 10, which forms an image on the recording medium, a feeder unit 20, which feeds the recording medium to the image forming unit 10, a discharge chute 30, which acts as a guide member guiding the recording medium, on which the image formation by the image forming unit 10 has been finished, toward the discharge unit 7, and the like, are stored inside the casing 3.

The feeder unit 20 is configured to have a sheet feeding tray 21, stored in a lowest portion of the casing 3; a sheet feeding roller 22, provided in an upper front end portion of the sheet feeding tray 21, which conveys the recording medium to the image forming unit 10; a separating roller 23 which separates, one sheet at a time, the recording medium conveyed by the sheet feeding roller 22; and a separating pad 24. The recording medium loaded in the sheet feeding tray 21, which makes a U-turn at an inner front side of the casing 3, is conveyed to the image forming unit 10 disposed in a substantially central portion inside the casing 3.

A paper dust removing roller 25, which removes paper dust adhering to an image formation surface (a printing surface) of the recording medium, is disposed on an external side an apex of the U-turned conveying path. The U-turned path extends from the sheet feeding tray 21 to the image forming unit 10, and curves in an approximate U shape. An opposed roller 26, which presses the conveyed recording medium against the paper dust removing roller 25, is disposed on an internal side of the apex.

Also, a registration roller 27, which has a pair of rollers and applies a conveying resistance to the recording medium to thereby control a conveying condition of the recording medium, is disposed at an entrance of the image forming unit 10 of the conveying path.

The image forming unit 10 is configured to have a scanner 40, a process cartridge 60, a fixing unit 70 and the like.

Next, a description will be given of a specific configuration of the scanner 40.

The scanner 40, as shown in FIG. 2, is provided in an upper portion inside the casing 3. The scanner 40 exposes a photosensitive drum 61 to light to form an electrostatic latent image on a surface of the drum.

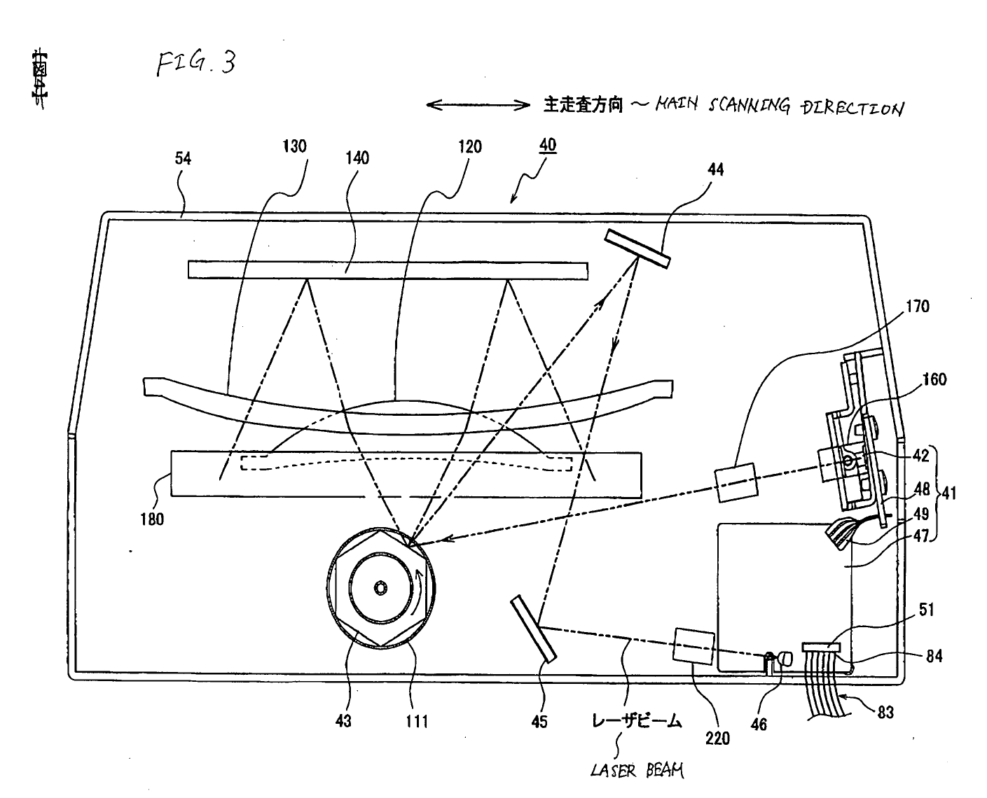

FIG. 3 is a plan view of an interior of the scanner 40 as seen from above.

As shown in the same figure, the scanner 40 includes a laser diode 42; a laser ejector unit 160, which has a collimating lens and ejects a laser beam; a cylindrical lens 170, which focuses the laser beam from the laser ejector unit 160; a polygon motor 111; a polygon mirror 43; an fθ lens 120; a reflecting mirror 140; a cylindrical lens 130; and a reflecting mirror 180 etc., all of which are affixed to a resin casing 54.

The polygon mirror 43 has mirror surfaces provided on each face of a regular polygon (a regular hexagon in the aspect) The polygon mirror 43 is rotationally driven by the polygon motor 111, deflects and scans the laser beam projected from the laser ejector unit 160 in a main scanning direction.

The fθ lens 120 converts the laser beam scanned at a uniform angular speed by the polygon mirror 43 into a uniform speed scan.

The reflecting mirror 140 turns back the laser beam, which passes through the fθ lens 120, reflecting it to the cylindrical lens 130 side.

The cylindrical lens 130 has a convergence ability in a sub-scanning direction in order to focus the laser beam on the surface of the photosensitive drum 61.

The reflecting mirror 180 turns back the laser beam, which passes through the cylindrical lens 130, reflecting it to the photosensitive drum 61 side.

With this configuration, as shown in FIG. 3, the laser beam ejected by the laser ejector unit 160 is converged in the sub-scanning direction by the cylindrical lens 170, and focused on the rotating polygon mirror 43. Then, the laser beam is deflected and scanned in the main scanning direction by the rotation of the polygon mirror 43, the laser beam passes through the fθ lens 120 and the cylindrical lens 130, and is projected onto the surface of the photosensitive drum 61.

Meanwhile, as shown in FIG. 3, the scanner 40 includes a photo diode 46 for the purpose of detecting a part of the laser beam, deflected and scanned by the polygon mirror 43, as a synchronization signal. The scanner 40 further includes, as a configuration for leading the laser beam to the photo diode 46, a reflecting mirror 44, a BD lens 220 and a reflecting mirror 45.

That is, as shown in FIG. 3, although the laser beam ejected by the laser ejector unit 160 is deflected and scanned by the polygon mirror 43, as described heretofore, one part of the laser beam which passes through the fθ lens 120 is reflected by the reflecting mirror 44 and further reflected by the reflecting mirror 45, passes through the BD lens 220 and is projected onto the photo diode 46.

Also, as shown in FIG. 3, the scanner 40 is equipped with a scanner controller 41 including an LD board 48, to which a laser diode 42 is attached; a PD board 47, to which the photo diode 46 that receives the laser beam from the laser diode 42 is attached, and the like.

In the scanner 40, the laser diode 42 and the photo diode 46 operate in conjunction in order to synchronize a scanning starting time of the laser beam. In this aspect, by detecting whether or not a light emission and a light reception is being carried out normally between the laser diode and the photo diode at that time, abnormalities including those of the optical system of the scanner 40 are detected.

At this point, operating in conjunction means that both of two electronic parts operate normally to achieve a predetermined function and does not mean that each two parts normally operate respectively. The electronic parts are not limited to the laser diode 42 and the photo diode 46. They may be an LED and a photo cell or an electric wave emitting element and a receiving element.

The process cartridge 60, as shown in FIG. 2, is disposed so as to be attachable and removable inside the casing 3, below the scanner 40. The process cartridge 40 includes the photosensitive drum 61, a charger 62, a transfer roller 63, a development cartridge 64, and the like.

The photosensitive drum 61, acting as an image carrier that carries an image to be transferred to the recording medium, is configured to have a cylindrical drum main body 61a, formed by positively charged photosensitive layers. An outermost layer of the photosensitive layers is formed of polycarbonate etc. In a center of the drum main body 61a, a drum shaft 61b extending along a longitudinal direction of the drum main body 61a is provided. The drum shaft 61b rotatably supports the drum main body 61a.

The charger 62, acting as a charging unit which charges the surface of the photosensitive drum 61, is opposed to the photosensitive drum 61 at a rear and diagonally above the photosensitive drum 61 which a certain interval so as not to come into contact with the photosensitive drum 61. As the charger 62, a Scolotron type charger is used in this aspect. The Scolotron type charger uses a corona discharge to substantially uniformly apply a positive charge to the surface of the photosensitive drum 61.

The transfer roller 63, being disposed opposite the photosensitive drum 61 and rotating in conjunction with a rotation of the photosensitive drum 61, acts as a transfer unit. When the recording medium passes a vicinity of the photosensitive drum 61, by applying a charge opposite to the charge applied to the photosensitive drum 61 (in the aspect, a negative charge) on the recording medium from a side opposite to the printing surface, the transfer roller 63 transfers the toner adhering to the surface of the photosensitive drum 61 to the printing surface of the recording medium.

The development cartridge 64 is configured to have a toner storage chamber 64a, in which the toner is stored, a toner supply roller 64b, which supplies the toner to the photosensitive drum 61, a development roller 64c, and the like.

The toner stored in the toner storage chamber 64a is supplied to the development roller 64c side by a rotation of the toner supply roller 64b. Further, the toner supplied to the development roller 64c side is held on a surface of the development roller 64c. After a thickness of the toner being held is adjusted to a constant (uniform) thickness by a layer thickness regulating blade 64d, the toner is supplied to the surface of the photosensitive drum 61 which is exposed by the scanner 40.

The fixing unit 70, being disposed downstream of the photosensitive drum 61 in a conveying direction of the recording medium, fixes the toner transferred to the recording medium by thermofusion. Specifically, the fixing unit 70 is configured to have a heating roller 71, disposed on the printing surface side of the recording medium to heat the toner, a pressurizing roller 72, disposed on an opposite side of the recording medium to the heating roller 71 to press the recording medium toward the heating roller 71 side, and the like.

Incidentally, the heating roller 71 includes a metal tube, a surface of which is coated with a fluorine resin, and a halogen lamp disposed inside the metal tube for the purpose of heating. The pressurizing roller 72 is configured by covering a metal roller shaft with a roller made of a rubber material.

In the image forming unit 10, the image is formed on the recording medium as described hereafter. That is, the surface of the photosensitive drum 61, after being uniformly positively charged as it rotates by the charger 62, is exposed by a high speed scanning of the laser beam projected from the scanner 40. In this way, the electrostatic latent image corresponding to the image to be formed on the recording medium is formed on the surface of the photosensitive drum 61.

Subsequently, by means of the rotation of the development roller 64c, the toner held and positively charged on the development roller 64c, when facing and in contact with the photosensitive drum 61, is supplied to the electrostatic latent image formed on the surface of the photosensitive drum 61. In short, the toner is supplied to the exposed portion of the surface of the uniformly positively charged photosensitive drum 61 exposed by the laser beam in which a potential is decreased. In this way, the electrostatic latent image of the photosensitive drum 61 is made into a visible image, whereby a toner image is held as an inverted image on the surface of the photosensitive drum 61.

After that, the toner image held on the surface of the photosensitive drum 61 is transferred to the recording medium by a transfer bias applied to the transfer roller 63. Then, the recording medium onto which the toner image is transferred is conveyed to the fixing unit 70 and heated, whereby the toner transferred as the toner image is fixed to the recording medium, and the image formation is complete.

The discharge chute 30 is disposed on the direction downstream side of the fixing unit 70 in the conveying direction of the recording medium. The discharge chute 30 guides the conveyance of the recording medium, on which the image formation by the image forming unit 10 is finished, forcing it to make a U-turn, toward the discharge unit 7 provided above the fixing unit 70.

The controller includes a main controller 80, which controls a whole of the laser printer 1; and a scanner controller 41, which controls the scanner 40. Both of the main controller 80 and the scanner controller 41 are connected by a flexible flat cable (FFC), which has flexibility.

The main controller 80, as shown in FIG. 1, includes a main board 81, a main cable 83, which is connected to the main board 81, and the like.

The main controller includes a not-shown CPU, ROM, I/O, power source and the like. The main controller inputs an image data from a computer etc. on a periphery of the laser printer and controls the feeder unit 20, the scanner 40, the process cartridge 60, the fixing unit 70 and the like inside the laser printer 1.

A connector 82, on which the main cable 83 is loaded, is loaded at an end of the main board 81. The connector 82 is an angled connector provided at the end of the main board 81. An end portion of the main cable 83 is fitted into the connector 82.

The main cable 83 is shown in the enlarged view of a bent portion of the cable in FIG. 1. The main cable 83 is bent twice at an angle of 90 degrees in an immediate proximity of the main board 81. And, after being distributed in a vertically-upwards direction inside the laser printer 1, the main cable 83 is bent at 90 degrees to distribute parallel to a floor surface along a frame 15. Further, the main cable 83 is bent back twice at an angle of 90 degrees to distribute toward the scanner 40.

The main cable 83 is an FFC in which plural signal lines are formed in a planar form. The signal lines at the end of the cable are processed such that the signal lines and the connector are directly connected and are conducted (this processing is referred to as a lead processing, and the portion processed in the terminal form is referred to as a lead 84).

The scanner controller 41, as shown in FIG. 3, includes a PD board 47; an LD board 48; a scanner cable 49 which connects both board 47 and 48; and the like. The scanner controller 49 in the aspect includes an FFC, which has flexibility.

The PD board 47 includes the photo diode 46 and a scanner control circuit 50. A connector 51 is loaded into an end of the PD board 47.

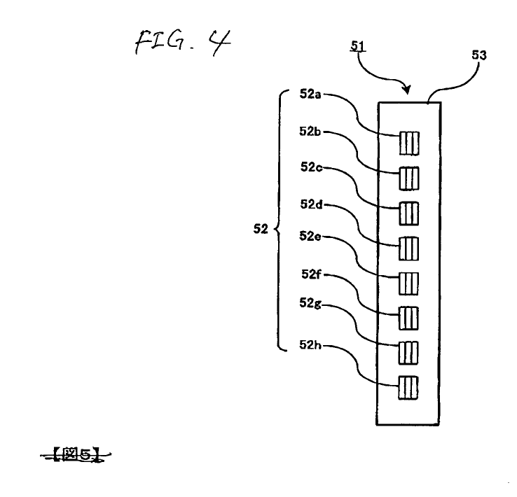

In the connector 51, as shown in FIG. 4, a plurality (eight in this aspect) of terminals 52 are positioned in a substantially straight line. The connector 51 is equipped with a longitudinal cover 53 installed so as to surround a perimeter of the plurality of terminals 52.

The substantially straight line does not refer to a straight line in the strictest meaning of the term, but includes a meaning wherein the terminals are not necessarily positioned in one straight line such as, for example, in a staggered form or a bow form.

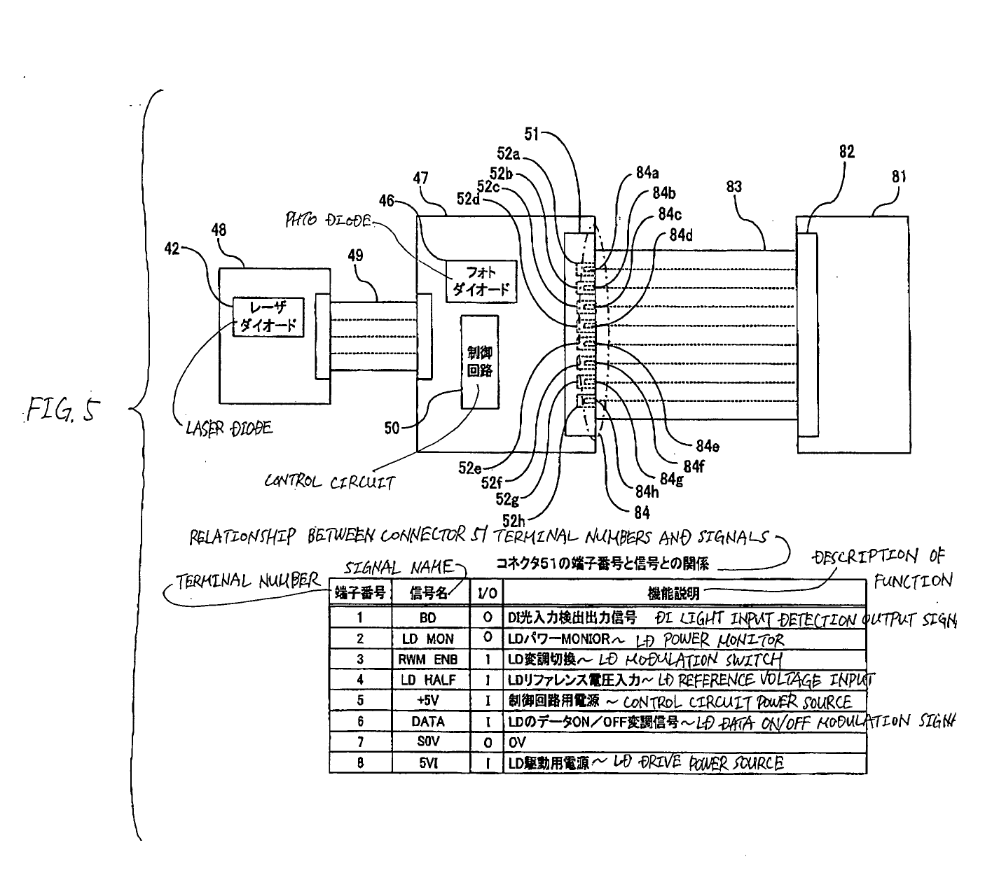

As shown in FIG. 5, the following kind of signal is input into or output from each of the terminals 52 on the connector 51. A DI light input detection output signal (a BD signal), indicating that the photo diode 46 has detected an input, is output from a first terminal 52a an output power monitor signal (an LD MON signal) of the laser diode 42 is output from a second terminal 52b, and a modulation switch signal (PWM ENB) of the laser diode 42 is input into a third terminal 52c.

Also, a reference voltage (LD HALF) of the laser diode 42 is input into a fourth terminal 52d, a control circuit power source (+5V), which is the power source for the whole of the scanner controller 41, is input into a fifth terminal 52e, and an on (light emitting)/off (light extinguishing) switch signal (a DATA signal) of the laser diode 42 is input into a sixth terminal 52f.

Furthermore, a ground (SOV) signal is input into a seventh terminal 52g, while a drive power source (5VI) of the laser diode 42 is input into an eighth terminal 52h.

In this way, a power source terminal 52e for the purpose of supplying the power to the scanner controller 41, that is, the PD board 47 and the LD board 48 is positioned as the fifth terminal 52e in an approximate center of a longitudinal direction of the connector 51.

Also, with respect to the power source terminal 52e (the fifth terminal), the first terminal, to which the photo diode 46, which is the light receiving element, is connected, is disposed at one end of the longitudinal direction of the connector 51, while the eighth terminal, to which the laser diode 42, which is the light emitting element operating in conjunction with the photo diode 46, is connected, is disposed at the other end.

A connector 82 loaded on a main board 81 also has a same configuration as the connector 51, wherein a signal corresponding to each terminal of the connector 51 is input into or output from each respective terminal of the connector 82.

Also, in the specification, the terminal refers to a contact portion for the purpose of carrying out the conduction electrically. For this reason, in the event that there is a plurality of each of the contact portions, it is said that there is a plurality of terminals. Specifically, apart from a pin and a socket, it is a so-called harmonica terminal and lead etc.

Also, the approximate center, as will be described hereafter, refers to a position in a portion, excluding the longitudinal direction end section of the connector 51, in which the terminal can maintain the electrical conductivity when the main cable 83 is in a semi-inserted condition in the connector 51.

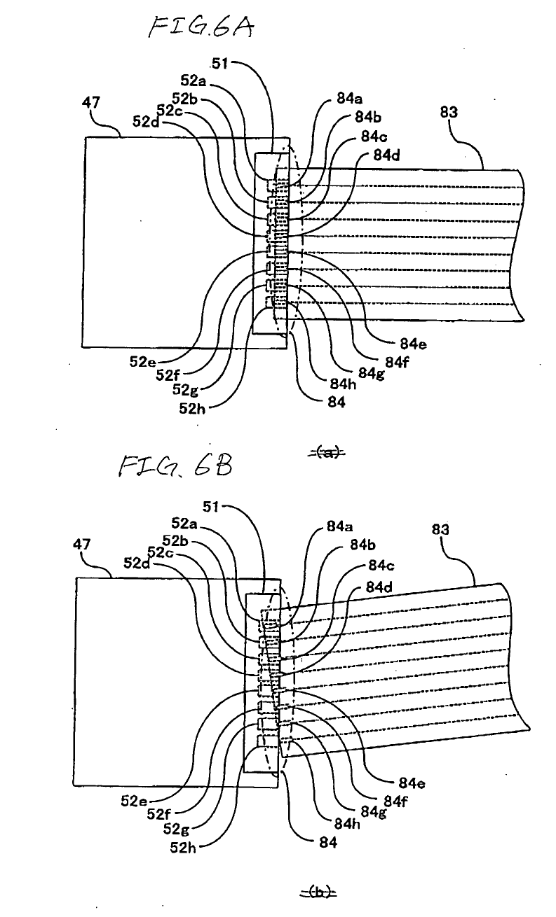

FIG. 6A shows a condition in which a lead 84 is normally inserted into the connector 51, while FIG. 6B shows a condition in which the lead 84 is semi-inserted into the connector 51.

In the condition shown in FIG. 6A, eight terminals of the lead 84, a first terminal 84a, a second terminal 84b, a third terminal 84c, a fourth terminal 84d, a fifth terminal 84e, a sixth terminal 84f, a seventh terminal 84g and an eighth terminal 84h, are all in normal contact with, respectively, the first terminal 52a to the eighth terminal 52h of the connector 51.

In the event that the lead 84 is inserted normally in the connector 51, as the control circuit power source and the other signals are input normally into the LD board 48, no problem occurs in electronic parts installed on the PD board 47 and the LD board 48.

On the contrary, as shown in FIG. 6B, in a so-called semi-inserted condition in which the lead 84 is inserted diagonally with respect to the connector 51, the seventh terminal 84g and the eighth terminal 84h of the lead 84, in the lower end portion of the figures are not inserted into the connector 51, causing a condition wherein the seventh terminal 84g and the eighth terminal 84h are not in contact with the seventh terminal 52g and the eighth terminal 52h of the connector 51, respectively.

However, even in the semi-inserted condition, as the fifth terminal 52e disposed in the approximate center in the longitudinal direction of the connector 51 is in an inserted condition, the fifth terminal 52e of the connector 51 and the fifth terminal 84e of the lead 84 are in contact, whereby conductivity can be maintained.

Then, as the respective fifth terminals of the connector 51 and the lead 84 are in contact, the control circuit power source is constantly supplied to the PC board 47, regardless of an existence or otherwise of the signal input.

Consequently, there is no likelihood of the electronic parts, such as the photo diode 46 loaded on the PD board 47 and the laser diode 42 loaded on the LD board 48, being broken or having their life spans shortened.

In short, when the laser diode drive power source (5VI) is supplied to the laser diode 42 via the eighth terminal 52h, and the image data is input into the LD board 48 via the sixth terminal, the laser diode 42 flashes in accordance with the image data.

Then, when the scanning of the laser beam by the polygon mirror 43 is started, in other words, when a writing of the electrostatic latent image onto the photosensitive drum 61 is started, the laser diode 42 emits a beam. Then the synchronization of the start of the scanning of the laser beam is carried out by the photo diode 46 receiving the laser beam.

When the laser beam is received by the photo diode 46, the DI light detection output signal is transmitted from the PD board 47 to the main board 81 via the first terminal. Consequently, in the main board 81, according to the existence or otherwise of the transmission of the DI light detection output signal, it can be determined whether or not an element of the optical system, such as the laser diode 42, the photo diode 46, the polygon mirror 43 and the fθ lens 120, is normal.

For example, in the event that the cable is in a semi-inserted condition, as either the laser diode drive power source (5VI) eighth terminal 52h or the DI light input detection output signal (BD) first terminal 52a is in a non-contact condition, the signal input or output of at least one of the laser diode 42 or the photo diode 46 is not carried outnormally.

Also, in the event that either the laser diode 42 or the photo diode 46 is defective, the emitting or the reception of the laser beam is not carried out normally. Furthermore, in the event that there is an abnormality in an element of the optical system such as the polygon mirror 43 and the reflecting mirrors 44 and 45, the light reception in the photo diode 46 is not carried out normally.

Consequently, by detecting, according to the existence or otherwise of the DI light input detection output signal, whether or not the light emission and the light reception of the laser beam between the laser diode 42 and the photo diode 46, which operate in conjunction, are carried out normally, as well as the semi-inserted condition of the main cable 83, it is possible to detect abnormalities including those in the laser diode 42, the photo diode 46 and the optical system.

Also, as the ground terminal (the seventh terminal 52g) is disposed between the laser diode drive power source (5VI) terminal (the eighth terminal 52h) and the control circuit power source terminal (the fifth terminal 52e), the drive power source of the electrical parts is electromagnetically shielded by the ground. Consequently, there is no likelihood of an abnormal operation of the electronic parts caused by a noise from the drive power source of the laser diode interfering with the drive power source of the laser diode.

Also, as the PD board 47 and the main board 81 are connected by the main cable 83, which has flexibility, it is possible to increase a freedom of design regarding a positioning of the PD board 47 and the main board 81 inside the laser printer 1.

In the aspect, the PD board 47, the LD board 48 and the scanner cable 49 correspond to electronic part attachment members in the invention.

Also, the fifth terminal 52e (the control circuit power source terminal) of the connector 51 corresponds to a first terminal in the invention, the eighth terminal 52h (the laser diode drive power source terminal) of the connector 51 corresponds to a second terminal in the invention, and the first terminal 52a to the fourth terminal 52d, and the sixth terminal 52f to the eighth terminal 52h, of the connector 51 correspond to signal terminals in the invention.

Also, the ground terminal (the seventh terminal 52g) of the connector 51 corresponds to a terminal connected to the ground in the invention.

Also, the connector 51 corresponds to an electric connection unit in the invention, the main board 81 corresponds to a control board in the invention, and the main cable 83 corresponds to a cable having flexibility in the invention.

Although a description of the aspect has been given heretofore, the aspect of the invention is no way limited to this aspect, and it goes without saying that a variety of forms can be incorporated given that they fall within a technical scope of the invention.

In the aspect, eight terminals 52 are formed positioned in a substantially straight line on the connector 51, wherein the terminal in the approximate center of the longitudinal direction of the connector 51 is the fifth terminal 52e, but it is also acceptable that the terminal in the approximate center is, for example, the fourth terminal 52d.

Also, in a case in which there are nine terminals positioned in the substantially straight line, the terminal in the approximate center of the longitudinal direction is not necessarily the fifth from an end but, when in a semi-inserted condition, as long as the contact with the terminal of the corresponding cable is continued, and the electrical conductivity is maintained, it is also acceptable that it is the fourth or the sixth terminal from the end.

Furthermore, regarding also the terminal at the end section of the connector 51, this refers not only to an endmost terminal of the eight terminals but, when in a semi-inserted condition, refers to the terminal which has lost contact with the terminal of the corresponding cable, and for which the electrical conductivity cannot be maintained, wherein it is also acceptable that it is the second or the seventh terminal from the endmost.

Also, although in the aspect the cable 83 has a connector at either end, the invention is not limited to this as, for example, it is also acceptable to affix one end of the cable 83 to the connector 51 using a welder unit such as a soldering. In this case, it goes without saying that by applying the invention to the connector 82 at the other end, it is possible to obtain an advantageous effect identical to that of the aspect.

Also, it is also acceptable that the electronic parts are not the laser diode 42 and the photo diode 46, as long as they are a light emitting element and a light receiving element operating in conjunction like the LED and the photo cell.

Furthermore, the electronic parts are not limited to those which emit light and receive light, as it is acceptable that they are a signal emitting unit and a signal receiving unit, operating in conjunction, which exchange some kind of signal.

Also, instead of loading the connector 51 on the PD board 47, it is also acceptable to process in such a way that the end of the PD board 47 is a projection, provide the terminal which carries out the electrical connection of the main cable 83 on that portion, and provide the connector on the main cable 83 side, thereby connecting the PD board 47 and the main cable 83.

Also, instead of connecting the PD board 47 and the LD board 48 by the scanner cable 49, it is also acceptable to integrally form the PD board 47 and the LD board 48 using a flexible board.

Furthermore, the object to which the cable is connected need not necessarily be a circuit board such as the PD board 47 as, as long as it has a power source terminal, it is also acceptable to use, for example, a head of an ink jet type or a thermal type laser printer, or another electronic instrument.

Also, although the cover 53 is provided on the connector 5, it is acceptable to eliminate the cover 53.

Also, it goes without saying that, as long as it connects the electronic part attachment member and the cable inside the electronic apparatus, the electronic apparatus is not limited to the laser printer.

According to the aspects, as the first power source terminal of the electronic part attachment member is positioned in the center of the connection unit, even in the event that, for example, the cable connected to the connection unit is in a semi-inserted condition, it is difficult for the first power source terminal to become detached, so the power source is supplied to the electronic parts attached to the electronic part attachment member, even in the semi-inserted condition.

Therefore, as there is no likelihood of a case in which only a signal is input in a condition wherein a power source is not supplied, there is no possibility of a damage and a shortening of a life span of the electronic parts.

Also, as a signal input terminal is positioned in at least an end section of the connection unit, when the cable is in a semi-inserted condition, a signal is not input into the electronic parts. Consequently, it is possible to detect the semi-inserted condition of the cable according to an operating condition of the electronic parts.

As the above, according to the aspects, it is possible to detect the semi-inserted condition of the cable without damaging the electronic parts attached to the electronic part attachment member.

In the invention, the electronic part attachment member means not only a circuit board formed of a single body to which the electronic parts are attached, but also includes a plurality of circuit boards, to which the electronic parts are attached, connected by a cable etc.

According to the aspects, the plurality of electronic parts includes a light emitting element and a light receiving element operating in conjunction; one of the light emitting element and the light receiving element is connected to one end section in the longitudinal direction of the electric connection unit; and the other is connected to the other end in the longitudinal direction of the electric connection unit.

According to the above, in a case in which the cable is in a semi-inserted condition, the input of the signal of at least one of the light emitting element and the light receiving element is not carried out normally. Also, in a case in which either of the light emitting element and the light receiving element is damaged, a light emission or a light reception is not carried out normally. Furthermore, in a case in which there is an abnormality in an optical system between the light emitting element and the light receiving element, the light reception by the light receiving element is not carried out normally.

Therefore, by detecting whether or not the light emission and the light reception between the light emitting element and the light receiving element are carried out normally, as well as the semi-inserted condition of the cable, it is possible to detect abnormalities including those in the light emitting element, the light receiving element and the optical system.

According to the aspects, the electronic part attachment member forms a scanner device which carries out an electrophotographic exposure, wherein the light emitting element is a laser diode, and the light receiving element is a photo diode, and wherein the light receiving element is connected to the signal terminals at one end section in the longitudinal direction of the electric connection unit, and furthermore, a second power source terminal, which supplies the drive power source to the light emitting element, is disposed at the other end in the longitudinal direction of the electric connection unit.

According to the above, by detecting whether or not the light emission and the light reception between the laser diode and the photo diode are carried out normally, it is possible to detect not only the semi-insertion of the cable, but also abnormalities including those in the optical system of the scanner device.

When the laser diode is caused to emit light, it may happen that a high frequency component of a drive power source of the laser diode interferes as noise with a drive power source of the electronic part, causing an abnormal operation of another electronic part.

At this point, according to the above aspects, a terminal connected to a ground (an earth) is furnished between the first power source terminal and the second power source terminal.

According to the above, as a ground line is disposed between the electronic part drive power source and the laser diode drive power source, the drive power source of the electrical part is electromagnetically shielded by the ground.

Therefore, there is no likelihood of the noise from the drive power source of the laser diode interfering with the drive power source of the electronic part, causing the abnormal operation of the electronic parts.

There is a case in which the electronic apparatus is furnished, apart from the electronic part attachment member, with a control circuit for the purpose of controlling the electronic parts of the electronic part attachment member. Then, to electrically connect the electronic part attachment member and a control board, a unit can be considered by which a connector etc. is provided on an end of both boards, thus directly connecting both boards by the connector etc.

However, by that unit, both boards, enlarged by being connected, have to be positioned inside the electronic apparatus. Consequently, a freedom of design decreases.

According to the aspects, by connecting the electronic part attachment member and the control board by a cable having a flexibility, the flexibility of the design regarding the positioning of the electronic part attachment member and the control board inside the electronic apparatus increases.

What is claimed is:

1. An electronic apparatus comprising:
an electronic part attachment member including a plurality of electronic parts; and
an electric connection unit provided on the electronic part attachment member, the electric connection unit including:
a first power source terminal that supplies a drive power source to the electronic parts; and
a plurality of signal terminals through which an electric signal input into the electronic parts flows, wherein;
the first power source terminal and the plurality of signal terminals are arranged in an substantially straight line;
the first power source terminal is disposed in a longitudinal direction approximate center of the electric connection unit; and
the signal terminals are disposed on at least one side in a longitudinal direction of the electric connection unit with respect to the first power source terminal.

2. An electronic apparatus according to claim 1, wherein:
the plurality of electronic parts includes a light emitting element and a light receiving element operating in conjunction;
one of the light emitting element and the light receiving element is connected to one side in the longitudinal direction of the electric connection unit; and
the other is connected to the other side in the longitudinal direction of the electric connection unit.

3. An electronic apparatus according to claim 2, wherein:
the electronic part attachment member forms a scanner device which carries out an electrophotographic exposure;
the light emitting element is a laser diode;
the light receiving element is a photo diode, and the light receiving element is connected to the signal terminals at one side in the longitudinal direction of the electric connection unit; and
a second power source terminal, which supplies the drive power source to the light emitting element, is disposed at the other side in the longitudinal direction of the electric connection unit.

4. An electronic apparatus according to claim 3, wherein
a terminal connected to a ground is furnished between the first power source terminal and the second power source terminal.

5. An electronic apparatus according to claim 1, further comprising
a control board that controls the electronic parts, wherein
the electronic part attachment member and the control board are connected by a cable having a flexibility.
